(19) United States
(12) Patent Application Publication
(10) Pub. No.: US 2026/0227010 A1
(43) Pub. Date: Aug. 6, 2026

(54) FLEXIBLE, FATIGUE RESISTANT, LOW PERMEATION FUEL DISPENSING HOSE USING F-TPV BARRIER LAYER

(71) Applicant: ContiTech Deutschland GmbH, Hannover (DE)

(72) Inventors: Lance Miller, Uniontown, OH (US); Andrew J. Speidel, Norfolk, NE (US); Jeffery Lofgren, Lincoln, NE (US)

(73) Assignee: ContiTech Deutschland GmbH, Hannover (DE)

(21) Appl. No.: 19/047,311

(22) Filed: Feb. 6, 2025

(51) Int. Cl. F16L 11/08; B67D 7/04; B67D 7/38; F16L 11/04

(52) U.S. Cl. CPC F16L 11/085; B67D 7/04; B67D 7/38; F16L 2011/047

(57) ABSTRACT

A fuel dispenser system includes a fuel dispenser hose having a tube layer, a barrier layer, an intermediate layer, a reinforcement layer, and a cover layer. The barrier layer is formed from a fluoro-thermoplastic vulcanizate (F-TPV), which is selected and constructed to provide: (i) a flexural modulus or tensile modulus of 700 MPa or less; (ii) an elongation at break of greater than 250%; (iii) a fatigue performance of greater than 250,000 cycles in tension and greater than 1 million cycles in compression; (iv) a bond strength between the F-TPV barrier layer and both the tube layer and intermediate layer of greater than a tear strength of the respective tube and intermediate layer, which is greater than at least 15 lbf/in; and (vi) a permeation rate of the overall hose which is less than 10 g/m²/day with CE10 fuel; thereby making the hose suitable for use in the fuel dispensing system.

### TECHNICAL FIELD

The present disclosure relates to a reinforced multilayer hose suitable for use in the conveyance of fuels such as gasoline, gasohol, diesel, and biodiesel. These hoses are of particular value for use in conjunction with both conventional and vapor recovery fuel dispensing systems, such as those used for fueling automobiles and trucks.

### BACKGROUND

Reinforced multilayer hoses are used in a wide variety of applications for transporting fluids such as liquids and gases. For example, one common application of a reinforced multilayer hose is as a fuel dispenser hose (also referred to as a fuel pump or curb pump hose) that is used to transfer fuel from a storage tank to a vehicle at the fuel dispenser. One conventional construction of a fuel dispenser hose is to provide an inner tube of elastomeric material, a permeation resistant barrier layer, a reinforcement layer, and an elastomeric cover layer. To provide low permeability to fuel, the barrier layer often is formed from a thermoplastic fluoropolymer, such as THV (tetrafluoroethylene-hexafluoropropylene-vinylidene fluoride).

### SUMMARY

At least one problem with using THV is that because it is allegedly associated with per- and polyfluoroalkyl substances (PFAS), this material is being discontinued and becoming increasingly difficult to source. Accordingly, there is a need in the market for fuel dispenser hoses to replace THV with other materials that can cooperate with other layers of the hose while providing suitable permeation resistance among other properties required for fuel dispenser hose.

At least one aspect of the present disclosure solves one or more problems associated with conventional fuel dispenser hoses containing THV barrier layers by providing a fuel dispenser hose having a barrier layer formed from a fluoro-thermoplastic vulcanizate material (F-TPV).

The present inventors have found, however, that not all F-TPV materials are suitable for use in fuel dispensing hose, and they discovered a careful balance of properties including flexibility, elongation, fatigue-resistance, bond performance, and permeation-resistance of the F-TPV barrier layer that is useful for making a suitable fuel dispenser hose.

According to an aspect, the present disclosure provides a fuel dispenser system, including: a fuel dispenser fluidly coupled to a source of fuel; a fuel dispenser hose fluidly coupled to the fuel dispenser for dispensing the fuel through a nozzle coupled to an end of the fuel dispenser hose; wherein the fuel dispenser hose comprises: an inner tube layer defining an internal lumen of the hose, the inner tube layer being formed from a first elastomeric composition having at least one fluoro-thermoplastic vulcanizate adhesion promoting agent; a barrier layer arranged over the inner tube layer, wherein the barrier layer is formed from a fluoro-thermoplastic vulcanizate (F-TPV); an intermediate layer arranged over the barrier layer, wherein the intermediate layer is formed from a second elastomeric composition having at least one fluoro-thermoplastic vulcanizate adhesion promoting agent; a reinforcement layer arranged over the intermediate layer, wherein the reinforcement layer is formed with braided steel wire; and an outermost cover layer arranged over the reinforcement layer, wherein the cover layer is formed from a third elastomeric composition; wherein the F-TPV barrier layer provides: a flexural modulus according to ASTM D790 or a tensile modulus according to ASTM D638 of 700 MPa or less; an elongation at break of greater than 250% when tested according to ASTM D638; a fatigue performance of greater than 250,000 cycles in tension and greater than 1 million cycles in compression, when tested according to ASTM D3629; a bond strength between the F-TPV barrier layer and the inner tube layer of greater than a tear strength of the inner tube layer, which is greater than at least 15 lbf/in, when tested according to ASTM D413; a bond strength between the F-TPV barrier layer and the intermediate layer of greater than a tear strength of the intermediate layer, which is greater than at least 15 lbf/in, when tested according to ASTM D413; and a permeation rate of the overall hose which is less than 10 g/m²/day with CE10 fuel, when tested according to UL330.

According to an aspect, the present disclosure also provides a method of using the fuel dispenser system.

According to an aspect, the present disclosure also provides a method of use of selecting materials and construction of the reinforced multilayer fuel dispensing hose for its specified use in a fuel dispensing system.

The following description and the annexed drawings set forth certain illustrative embodiments according to the present disclosure. These embodiments are indicative, however, of but a few of the various ways in which the principles of the invention may be employed. Other objects, advantages and novel features according to aspects of the present disclosure will become apparent from the following detailed description when considered in conjunction with the drawings.

### BRIEF DESCRIPTION OF THE DRAWINGS

The annexed drawings, which are not necessarily to scale, show various aspects according to the present disclosure.

FIG. 1 is a schematic view of a fuel dispenser system according to the present disclosure including a fuel dispenser fluidly coupled to a source of fuel, and a fuel dispenser hose fluidly coupled to the fuel dispenser for dispensing fuel via a nozzle.

FIG. 2 is a cut-away view of an exemplary fuel dispenser hose according to the present disclosure which illustrates the various layers therein.

FIG. 3 is a cut-away view of an alternative embodiment of the fuel dispenser hose according to this disclosure which includes a tie layer which is situated between the tube layer and the barrier layer.

FIG. 4 illustrates a reinforcement layer having a wire braid pattern which is situated over an intermediate layer (the cover layer is not shown),

### DETAILED DESCRIPTION

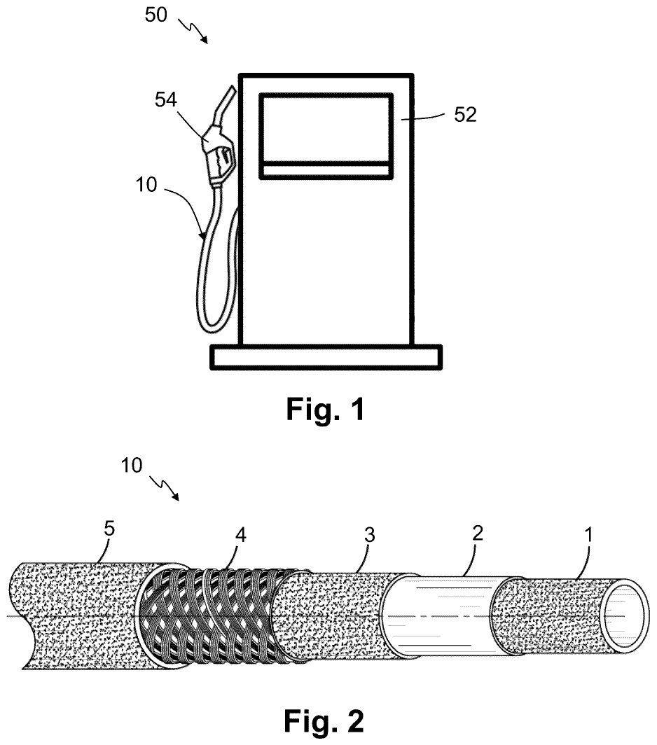

FIG. 1 is a schematic view of an exemplary fuel dispenser system 50 including a fuel dispenser 52 fluidly coupled to a source of fuel, and an exemplary fuel dispenser hose 10 according to the present disclosure that is fluidly coupled to the fuel dispenser 50 for dispensing fuel via a nozzle 54.

An exemplary embodiment of the fuel dispenser hose 10 is illustrated in further detail in FIG. 2. The fuel dispenser hose 10 typically has an inside diameter which is within the range of about 0.6 inch (15 mm) to about 1.2 inch (30 mm) and has an outside diameter of about 0.9 inch (23 mm) to about 1.8 inch (46 mm). For instance, the fuel dispenser hose 10 can have an inside diameter of % inch (16 mm), ¾ inch (19 mm), ⅞ inch (22 mm), or 1 inch (25 mm). As a specific example, the fuel dispenser hose can have in inside diameter of about 0.720 inch to 0.780 inch (18 mm to 20 mm) and an outside diameter of about 1.115 inch to 1.165 inch (28 mm to 30 mm).

The hose 10 has an inner tube layer 1, relative to the radial direction of the hose and the longitudinal hose axis. The tube layer 1 is the innermost layer of the hose and defines the lumen through which fuel is transferred. The tube layer 1 material and construction are therefore selected based at least upon flexibility and chemical resistance to hydrocarbon fuel (e.g., gasoline, gasohol (e.g., CE10), diesel, or biodiesel) when used in the fuel dispensing system, such as leaching performance, fuel swell, or the like. In exemplary embodiments, the construction of the tube layer 1 is typically about 0.045 inch to 0.095 inch thick. The tube layer is more typically from 0.060 inch to 0.080 inch thick. The inner tube layer 1 is frequently referred to in the art as simply the “inner tube” or as simply as the “core.”

In exemplary embodiments, the tube layer 1 is formed from an elastomeric composition, such as a nitrile rubber having an acrylonitrile content which is within the range of about 28 weight percent to about 50 weight percent. The nitrile rubber will typically have an acrylonitrile content which is within the range of about 30 weight percent to about 45 weight percent and will more typically have an acrylonitrile content which is within the range of about 35 weight percent to about 45 weight percent. In many cases the nitrile rubber will have an acrylonitrile content which is within the range of about 38 weight percent to about 42 weight percent. The nitrile rubber utilized in the tube layer is cured with a peroxide curative and a coagent which are employed at a level of about 4 to 10 phr (parts by weight per 100 parts by weight of rubber). The tube layer 1 can be void of fluorothermoplastic adhesion promoting agents.

For example, peroxides such as dicumyl peroxide, .α-α-bis(t-butylperoxide)diisopropylbenzene, benzoyl peroxide, 2,4-dichlorobenzoyl peroxide, 1,1-bis(t-butylperoxy) 3,3,5-trimethylcyclohexane, 2,5-dimethyl-2,5-bis(t-butylperoxy) hexane, 2,5-dimethyl-2,5-bis(t-butylperoxy) hexyne-3, and n-butyl 4,4-bis(t-butylperoxy) valerate can be employed in curing the nitrile rubber employed in the tube layer of the hose. The most preferred and commercially available peroxide curatives are Di-Cup® 40 KE and Vul-Cup® 40 KE from Arkema Inc. From 1 to about 10 parts of peroxide are generally utilized based on 100 parts of base polymer.

The nitrile rubber employed in the tube layer of the hose of this disclosure can also contain various additives in conventional or suitable amounts known to persons having ordinary skill in the art. Such additives may include, and are not limited to retardants to prevent an unduly quick cure, antioxidants, processing aids, reinforcing agents and fillers, such as carbon black, silica, other mineral fillers, lignin, and the like. Reinforcing fillers are typically utilized at a level which is within the range of 10 phr to 150 phr.

The nitrile rubber used in the tube layer 1 may further include at least one fluorothermoplastic adhesion promoting agent. This adhesion promoting agent is comprised of (a) at least one metal oxide selected from the group consisting of magnesium oxide, calcium oxide, and hydrotalcite, and (b) an organo-onium salt, or a diamine salt. The metal oxide is typically present at a level within the range of 15 phr to 40 phr and is preferably present at a level within the range of 20 phr to 30 phr. The organo-onium salt is typically present at a level within the range of 3 phr to 8 phr with the diamine salt being present at a level within the range of 1 phr to 4 phr. It is preferred for the organo-onium salt to be present at a level within the range of 4 phr to 6 phr with the diamine salt being present at a level within the range of 2 phr to 3 phr. Additional nitrile rubber formulations that can be used in the tube layer are described in U.S. Pat. Nos. 6,270,901 and 6,482,522. The teachings of U.S. Pat. Nos. 6,270,901 and 6,482,522 are incorporated herein by reference for the purpose of describing various nitrile rubber formulations which can be utilized in the tube layer of the hoses of this disclosure.

A barrier layer 2 is disposed outwardly from the tube layer 1. The barrier layer 2 material and construction are selected based at least upon flexibility, elongation, fatigue performance, bonding performance to other layers, and fuel permeation rate when used in the fuel dispensing system. The barrier layer is formed from a fluoro-thermoplastic vulcanizate (F-TPV). In exemplary embodiments, the construction of barrier layer is typically from 0.003 inch to 0.017 inch thick. The barrier layer is more typically from 0.006 inch to 0.014 inch thick.

The F-TPV barrier layer 2 is a high-performance elastomeric material designed to provide a combination of rubber-like flexibility, thermal stability, chemical and fatigue resistance, low fuel permeation and ease of processability. This unique F-TPV material is a specific subclass of thermoplastic elastomers (TPEs), and includes an elastomeric phase composed of fluoroelastomer that is dynamically vulcanized within a thermoplastic matrix. The dynamic vulcanization process ensures that the rubber phase is chemically crosslinked, resulting in a morphology where finely dispersed elastomeric domains are embedded in a continuous thermoplastic phase. This structure allows F-TPVs to exhibit exceptional mechanical and thermal properties while being processable like a standard thermoplastic.

The primary components of F-TPV are fluoroelastomer, a thermoplastic matrix, and optional compatibilizers and additives. The fluoroelastomer may be based on copolymers of vinylidene fluoride (VDF), hexafluoropropylene (HFP), and/or tetrafluoroethylene (TFE), which provides the elastomeric phase with excellent resistance to fuels and high temperatures. Fluoroelastomers such as those in the FKM (fluorocarbon elastomer) family may be used for this purpose. The thermoplastic matrix may be a fluorinated thermoplastic, such as polyvinylidene fluoride (PVDF) or ethylene tetrafluoroethylene (ETFE). These materials are chosen for their superior compatibility with the fluoroelastomer phase, high thermal stability, and robust mechanical properties.

Compatibilizers may be incorporated to enhance the interfacial adhesion between the fluoroelastomer and the fluoroplastic matrix, ensuring a homogenous and stable blend. These compatibilizers can include block copolymers or modified fluoropolymers with functional groups that interact with both the elastomer and thermoplastic phases. Additionally, crosslinking agents, such as peroxides or bisphenol-based curing systems, are used during dynamic vulcanization to chemically crosslink the fluoroelastomer. This crosslinking imparts elasticity and improves the durability of the material under mechanical and thermal stress. An example of the components and processing of F-TPV material is described in further detail in U.S. Pub. 2008/0032080 (Faulkner et al.), which is incorporated herein by reference in its entirety.

The F-TPV barrier layer can be processed using standard thermoplastic techniques, such as extrusion, enabling efficient production with the other layers of the hose. The thermoplastic matrix may exhibit a melt temperature typically ranging from 200° C. to 250° C., depending on the specific fluoropolymer used. Notably, the vulcanized fluoroelastomer phase does not melt, maintaining its structural integrity even under high thermal conditions.

As discussed in further detail below, the present inventors discovered through experimentation that not all F-TPV materials are suitable for use as the barrier layer 2 of the fuel dispensing hose 10 even if within the same general class of material. Rather, through their research, they discovered sources of the problem(s) with such class of materials, and other barrier materials, and thereafter discovered a careful balance of properties including flexibility, elongation, fatigue-resistance, bonding performance, and permeation-resistance of the F-TPV barrier layer that is required for making the fuel dispenser hose 10 according to exemplary embodiment(s).

Turning again to FIG. 2, an intermediate layer 3 may be situated over and outwardly from the barrier layer 2 of the hose 10. The intermediate layer 3 material and construction are selected based at least upon flexibility, protection of the barrier layer 2, and optionally bonding performance, when used in the fuel dispensing system. In exemplary embodiments, the construction of the intermediate layer 3 (also referred to as a friction layer) is typically from 0.015 inch to 0.075 inch thick and will preferably be from 0.030 inch to 0.050 inch thick. The intermediate layer 3 will typically be in direct contact with the barrier layer 2. The intermediate layer 3 is formed from an elastomeric composition, such as a peroxide cured nitrile rubber and can be of the same formulation as is used in the tube layer 1. However, in some cases it may be desirable to employ a different nitrile rubber formulation in the intermediate layer. For instance, in some cases it may be desirable to employ a nitrile rubber having a lower level of acrylonitrile content.

The fuel dispenser hose 10 includes a reinforcing layer 4 which is disposed outwardly of the barrier layer 2, such as situated over and outwardly from the intermediate layer 3. The reinforcement layer 4 material and construction are selected based at least upon flexibility without kinking, tensile strength, and strength to resist burst pressure, or the like, when used in the fuel dispensing system. As shown in FIG. 4, the reinforcing layer 4 may be constructed to be in direct contact with the friction layer 3. In exemplary embodiments, the reinforcing layer 4 is constructed by braiding steel wires which are typically brass plated. For instance, the reinforcing layer 4 can be manufactured utilizing a braiding machine having 16 to 36 carriers (bobbins of wire), with 2 to 12 wire ends of 0.006 to 0.015 inch (0.15 mm to 0.38 mm) gage. As a more specific example, the reinforcing layer 4 can be manufactured utilizing a braiding machine having 24 carriers (bobbins of wire) with 6 wire ends of 0.012 inch (0.3 mm) gage wire. In any case, it is important for the braided steel wire used in the reinforcing layer 4 to have a wire pack coverage which is within the range of about 30 percent to about 60 percent. In other words, the wires of the reinforcement layer cover from 30 percent to 60 percent of the surface area of the friction layer 3 with the remaining 40 percent to 70 percent of the friction layer 3 being exposed through windows 15 in the braid pattern. The braided steel wire will typically have a wire pack coverage which is within the range of about 32 percent to about 55 percent and will preferably have a wire pack coverage which is within the range of about 35 percent to about 50 percent. The braided steel wire will more preferably have a wire pack coverage which is within the range of about 40 percent to about 45 percent. The reinforcement layer 4 may include one or more layers of reinforcement (e.g., braided steel wire) separated by further intermediate layers.

A cover layer 5 is positional outwardly from the reinforcement layer 4. The cover layer material and construction are selected based at least upon flexibility and environmental resistance when used in the fuel dispensing system. Such environmental resistance may include resistance to weathering, ozone, UV light, and temperature extremes. The cover layer also may be abrasion resistant to handle rough handling and contact with the ground or equipment. In exemplary embodiments, the cover layer 5 construction is typically from 0.050 inch to 0.1 inch thick and is preferably 0.065 inch to 0.085 inch thick. In exemplary embodiments, the cover layer 5 is formed from an elastomeric composition, such as a chlorinated polyethylene elastomer (CPE) which typically has a chlorine content which is within the range of 30 percent to 36 percent. It is preferred for the chlorinated polyethylene to have a chlorine content which is within the range of 34 percent to 36 percent.

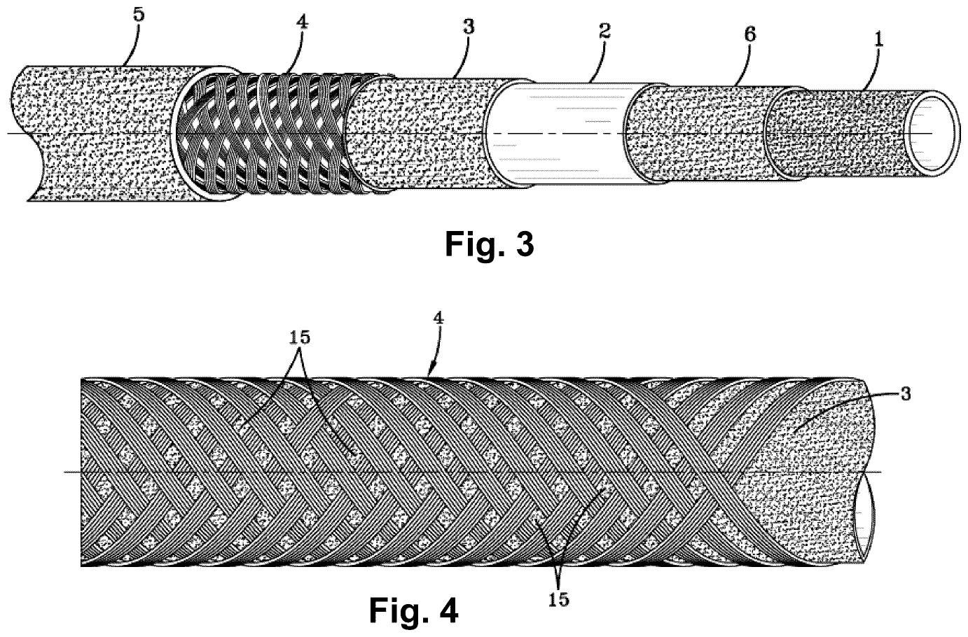

In an alternative embodiment of this disclosure as illustrated in FIG. 3, the tube layer 1 is optimized for fuel resistance and adhesion to a tie layer 6 which is situated outwardly from the tube layer 1 and inwardly from the barrier layer 3. In this alternative design, the adhesion promoting agents are removed from the tube layer 1, thus optimizing its fuel resistance, volume swell, and adhesion to the rubber tie layer 6. This design can also lead to cost reduction. The other features of the hose in FIG. 3 are the same as that in FIG. 2 and consequently the same description of the exemplary embodiment(s) applies.

### EXAMPLES

Various barrier layer materials were tested for their suitability in the fuel dispensing hose 10. These test results are shown in Tables 1a and 1b, in which melt point was tested according to ASTM D4591, flexural modulus was tested according to ASTM D790, tensile modulus was tested according to ASTM D638, elongation at break was tested according to ASTM D638, glass transition temperature was tested according to ASTM D7028, permeation rate of the F-TPV material itself was tested according to SAE J2665 at room temperature, adhesion or bond strength was tested according to ASTM D413, and fatigue performance was tested according to ASTM D3629.

TABLE 1
a:

| | | EX-1 | CE-1 | CE-2 | CE-3 | CE-4 |
|---|---|---|---|---|---|---|
| Properties | Unit | F-TPV | THV | F-TPV | F-TPV | F-TPV |
| Sp Gravity | g/cm\hat{ }3 | 1.87 | 2.01 | — | — | 1.8 |
| Melt Point | C | 220 | 165 | 220 | 220 | 165 |
| Flexural Modulus | MPa | ~400* | 210 | — | — | — |
| Tensile Modulus | MPa | 410 | — | 340 | 261 | 750 |
| Elongation @ | % | 440 | 520 | 410 | 370 | — |
| Break | | | | | | |
| Glass Transition | C. | — | 26 | — | — | |
| Temp | | | | | | |
| Permeation | g/m\hat{ }2/day | 0.6 | 0.3 | 0.5 | 2.2 | 0.8 |
| Adhesion | Ibf/in | Stock tear | Stock tear | <5 | | Stock tear |
| Texus Flex Fatigue | | | | | | |
| tension | cycles | 288,000 | 288,000 | | | 144,000 |
| compression | cycles | >1 million | >1 million | | | 432,000 |

b (same units as Table 1a):

| | CE-5 | CE-6 | CE-7 | CE-8 | CE-9 | CE-10 | CE-11 |
|---|---|---|---|---|---|---|---|
| Properties | F-TPV | F-TPV | PVDF | PVDF | PVDF | POK | POK |
| Sp Gravity | — | — | 1.76 | 1.78 | 1.8 | 1.16 | 1.22 |
| Melt Point | — | — | 165 | 165 | 164 | — | 197 |
| Flexural Modulus | — | — | 720 | 720 | 275 | 300 | 900 |
| Tensile Modulus | 340 | 260 | 930 | 700 | 276 | 300 | 950 |
| Elongation @ | — | — | 300-500 | 300-550 | >500 | — | 300 |
| Break | | | | | | | |
| Glass Transition | — | — | −40 | −40 | −42 | 12 | — |
| Temp | | | | | | | |
| Permeation | — | — | 2.9 | 1.8 | 6 | — | 1.69 |
| Adhesion | 0.6 | 3 | Stock | Stock tear | Stock | <5 | <5 |
| | | | tear | | tear | | |
| Texus Flex | | | | | | | |
| Fatigue | | | | | | | |
| Tension | | | >1 million | >1 million | 288,000 | | 864,000 |
| Compression | | | >1 million | >1 million | 576,000 | | >1 million |

Table 1a & 1b Key
EX-1: F-TPV-Cri-PlastMP F-TPV-2401 from Cri-Tech Inc., Hanover, MA (US)
CE-1: THV (tetrafluoroethylene, hexafluoropropylene, and vinylidene fluoride)-Dyneon
THV500GZ from 3M, St. Paul, MN (US)
CE-2: F-TPV-Cri-PlastMP F-TPV-2402 from Cri-Tech Inc., Hanover, MA (US)
CE-3: F-TPV-Cri-PlastMP F-TPV-2403 from Cri-Tech Inc., Hanover, MA (US)
CE-4: F-TPV material (Proprietary)
CE-5: F-TPV material (Proprietary)
CE-6: F-TPV material (Proprietary)
CE-7: PVDF (Polyvinylidene fluoride)-Kynar 3120-50 from Arkema, Inc., PÅ (US).
CE-8: PVDF (Polyvinylidene fluoride)-Kynar 3120-10 from Arkema, Inc., PA (US)
CE-9: PVDF (Polyvinylidene fluoride)-Kynar 3030-50 from Arkema, Inc., PA (US)
CE-10: POK (polyketone)-Poketone M71FR2B from Hyosung (KR)
CE-11: POK (polyketone)-Poketone M710F from Hyosung (KR)
*Property not tested but assumed based on an approximate 1:1 correlation (i.e., within about 10-15%) between flexural modulus and tensile modulus for these classes of materials.

The present inventors, through their research in manufacturing fuel dispensing hose with barrier layer materials, have discovered a careful balance of required properties according to exemplary embodiment(s). For example, the inventors have found that if the barrier layer material has a flexural modulus or tensile modulus of greater than 700 MPa, then the product will kink during extrusion manufacturing. Therefore, the flexural modulus according to ASTM D790 should be 700 MPa or less or the tensile modulus according to ASTM D638 should be 700 MPa or less. The inventors also have found that insubstantial elongation results in possible cracking or tearing during bending, and thus the elongation at break should be greater than 250% when tested according to ASTM D638. In addition, because of the service life of such fuel dispensing hose, the barrier layer should achieve a fatigue performance of greater than 250,000 cycles in tension and greater than 1 million cycles in compression, when tested according to ASTM D3629. The barrier layer is sandwiched between the inner tube layer and intermediate layer in exemplary embodiments, and should have suitable adhesion to these layers to prevent separation in the hose. Thus, the barrier layer should have a bond strength with the inner tube layer and the intermediate later which is greater than the tear strength of these respective layers (“stock tear”), which this tear strength is greater than at least 15 lbf/in, when tested according to ASTM D413. To provide low permeability to hydrocarbon fuel, the overall hose as constructed with its respective layers (tube, barrier, intermediate, reinforcement, cover) should have a permeation rate of less than 10 g/m²/day with CE10 fuel, when tested according to UL330]. The work of the inventors has found that lab testing of the barrier layer material itself should be significantly lower than this when tested according to SAE J2665 at room temperature.

Based on the testing of the inventors and their discovered learnings, it was found that only one F-TPV material (EX-1) satisfied the careful balance of the foregoing properties with the above-mentioned values, despite it being understood that the other F-TPV materials are of the same general class. The remaining materials tested in Tables 1a and 1b were deficient in at least one property according to the test results and discovered criteria. For example, comparative example 1 (CE-1) was a conventional THV material that will no longer be commercially available. Comparative example 2 (CE-2) was an F-TPV material that exhibited insufficient bond strength with the inner tube material (nitrile elastomer) and thus does not satisfy at least this criteria. Comparative example 3 (CE-3) was an F-TPV material that exhibited insufficient permeation resistance and thus does not satisfy at least this criteria. Comparative example 4 (CE-4) was an F-TPV material that exhibited insufficient fatigue performance and thus does not satisfy at least this criteria, and also had relatively high tensile modulus. Comparative example 5 (CE-5) was an F-TPV material that had insufficient bond strength with the inner tube material (nitrile elastomer) and thus does not satisfy at least this criteria. Comparative example 6 (CE-6) was an F-TPV material that exhibited insufficient bond strength with the inner tube material (nitrile rubber) and thus does not satisfy at least this criteria. Comparative example 7 (CE-7) was a PVDF material that exhibited insufficient permeation performance and thus does not satisfy at least this criteria, and also had relatively high tensile and flexural modulus. Comparative example 8 (CE-8) is a PVDF which exhibited relatively high permeation performance, and exhibited relatively high flex and tensile modulus, and so on balance did not satisfy the criteria. Comparative example 9 (CE-9) was a PVDF material that exhibited insufficient permeation performance and thus does not satisfy at least this criteria, and also had insufficient fatigue performance. Comparative example 10 (CE-10) was a polyketone material that exhibited insufficient adhesion with the inner tube material (nitrile elastomer) and thus does not satisfy at least this criteria. Comparative example 11 (CE-11) was a polyketone material that exhibited insufficient adhesion with the inner tube material (nitrile elastomer) and had too high tensile and flex modulus and thus does not satisfy at least this criteria, and also had relatively high permeation of CE-10 fuel.

Other useful properties discovered by the inventors is that the barrier layer may have a melt point in a range from about 150C to about 240 deg C. In addition, the exemplary F-TPV barrier layer is understood to have suitable cold performance for its use in fuel dispensing systems, as it is understood that the glass transition temperature may be below 26 degrees C. It is understood by the present inventors that Example 1 satisfies both of these melt point and glass transition temperature properties as well.

According to an aspect, the present disclosure provides a fuel dispenser system, including: a fuel dispenser fluidly coupled to a source of fuel; a fuel dispenser hose fluidly coupled to the fuel dispenser for dispensing the fuel through a nozzle coupled to an end of the fuel dispenser hose; wherein the fuel dispenser hose comprises: an inner tube layer defining an internal lumen of the hose, the inner tube layer being formed from a first elastomeric composition having at least one fluoro-thermoplastic vulcanizate adhesion promoting agent; a barrier layer arranged over the inner tube layer, wherein the barrier layer is formed from a fluoro-thermoplastic vulcanizate (F-TPV); an intermediate layer arranged over the barrier layer, wherein the intermediate layer is formed from a second elastomeric composition having at least one fluoro-thermoplastic vulcanizate adhesion promoting agent; a reinforcement layer arranged over the intermediate layer, wherein the reinforcement layer is formed with braided steel wire; and an outermost cover layer arranged over the reinforcement layer, wherein the cover layer is formed from a third elastomeric composition; wherein the F-TPV barrier layer provides: a flexural modulus according to ASTM D790 or a tensile modulus according to ASTM D638 of 700 MPa or less; an elongation at break of greater than 250% when tested according to ASTM D638; a fatigue performance of greater than 250,000 cycles in tension and greater than 1 million cycles in compression, when tested according to ASTM D3629; a bond strength between the F-TPV barrier layer and the inner tube layer of greater than a tear strength of the inner tube layer, which is greater than at least 15 lbf/in, when tested according to ASTM D413; a bond strength between the F-TPV barrier layer and the intermediate layer of greater than a tear strength of the intermediate layer, which is greater than at least 15 lbf/in, when tested according to ASTM D413; and a permeation rate of the overall hose which is less than 10 g/m²/day with CE10 fuel, when tested according to UL330.

According to an aspect, the present disclosure provides method of using the system according to the foregoing, including: transferring the fuel through the hose via the fuel dispenser; and dispensing the fuel through the nozzle.

According to another aspect, the present disclosure provides a method of use of selecting materials and construction of a reinforced multilayer fuel dispensing hose for its specified use in a fuel dispensing system, including: selecting a tube material and construction to form an inner tube layer based at least upon inner tube properties including flexibility and chemical resistance to hydrocarbon fuel when used in the fuel dispensing system; constructing the inner tube layer with the selected tube material and construction as the innermost layer of the hose which defines a lumen, wherein the selected tube material is an elastomeric composition having at least one fluoro-thermoplastic vulcanizate adhesion promoting agent; and the construction of the inner tube layer with the selected elastomeric composition satisfies the inner tube properties when the hose is cured; selecting a barrier material and construction to form a barrier layer based at least upon barrier layer properties; constructing the barrier layer with the selected barrier material and construction outwardly of the tube layer, wherein the selected barrier material is a fluoro-thermoplastic vulcanizate (F-TPV), and the construction of the barrier layer with the selected F-TPV satisfies the barrier layer properties when the hose is cured; selecting an intermediate layer material and construction to form an intermediate layer based at least upon intermediate layer properties; constructing the intermediate layer with the selected intermediate layer material and construction outwardly of the barrier layer, wherein the selected intermediate layer is an elastomeric composition having at least one fluoro-thermoplastic vulcanizate adhesion promoting agent, and the construction of the intermediate layer with the selected elastomeric composition satisfies the intermediate layer properties when the hose is cured; selecting a reinforcement material and construction to form a reinforcement layer based at least upon reinforcement layer properties including flexibility without kinking and strength to resist burst pressure when used in the fuel dispensing system; constructing the reinforcement layer with the selected reinforcement material and construction outwardly of the barrier layer, wherein the selected reinforcement material and construction includes braided steel wire, and the construction of the reinforcement layer with the selected braided steel wire satisfies the reinforcement layer properties when the hose is cured; selecting a cover material and construction to form a cover layer based at least upon cover layer properties including flexibility and environmental resistance when used in the fuel dispensing system; constructing the cover layer with the selected cover material and construction outwardly of the reinforcement layer and forming the outermost layer of the hose, wherein the selected cover material is an elastomeric composition, and the construction of the cover layer with the selected elastomeric composition satisfies the cover layer properties when the hose is cured; wherein the selecting of the barrier layer properties and constructing of the barrier layer with the selected F-TPV that satisfies the barrier layer properties is based at least upon the F-TPV providing: a flexural modulus according to ASTM D790 or a tensile modulus according to ASTM D638 of 700 MPa or less; an elongation at break of greater than 250% when tested according to ASTM D638; a fatigue performance of greater than 250,000 cycles in tension and greater than 1 million cycles in compression, when tested according to ASTM D3629; a bond strength between the F-TPV barrier layer and the inner tube layer of greater than a tear strength of the inner tube layer, which is greater than at least 15 lbf/in, when tested according to ASTM D413; a bond strength between the F-TPV barrier layer and the intermediate layer of greater than a tear strength of the intermediate layer, which is greater than at least 15 lbf/in, when tested according to ASTM D413; and a permeation rate of the overall hose which is less than 10 g/m²/day with CE10 fuel, when tested according to UL330; the method further comprising: curing the reinforced multilayer fuel dispensing hose with its respectively constructed layers, such that each of the respective layers, as constructed with its selected material, satisfies its respective properties, and the overall hose it is suitable for use in the fuel dispensing system.

Exemplary embodiment(s) may combine one or more features of the foregoing aspects with each other in any suitable manner; and/or exemplary embodiment(s) may include one or more of any of the foregoing features in the description and/or one or more of any of the features in the appended claims, in which one or more of any of these feature(s) may be combined with the foregoing aspect(s) or the other feature(s) separately or in any suitable combination.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. Thus, while a particular feature may have been described with respect to only one or more of several embodiments, such feature may be combined with one or more other features of the other embodiments, separately or in any combination. The same may also be varied in many ways. Such variations are not to be regarded as a departure from the disclosure, and all such modifications are intended to be included within the scope of the disclosure. as may be desired and advantageous for any given or particular application.

Any background information contained in this disclosure is to facilitate a better understanding of the various aspects described herein. It should be understood that any such background statements are to be read in this light, and not as admissions of prior art. Likewise, the description and examples are presented herein solely for the purpose of illustrating the various embodiments of the disclosure and should not be construed as a limitation to the scope and applicability of the disclosure.

The phrase “and/or” as used in this disclosure should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The word “or” as used in this disclosure should be understood as being inclusive and not exclusive. For example, when separating items in a list, “or” or “and/or” shall be interpreted as being inclusive, i.e., the inclusion of at least one, but also including more than one, of a number or list of elements, and, optionally, additional unlisted items. For example, a condition A or B is satisfied by anyone of the following: A is true (or present) and B is false (or not present), A is false (or not present) and B is true (or present), and both A and B are true (or present). Only terms clearly indicating exclusivity should be interpreted as indicating exclusive alternatives (i.e. “one or the other but not both”), such as “either,” “only one of,” or “exactly one of.” In other words, such terms of exclusivity refer to the inclusion of exactly one element of a number or list of elements.

Any references to “one embodiment” or “an embodiment” as used herein is understood to mean that a particular element, feature, structure, or characteristic described in connection with the embodiment is included in at least one embodiment. The appearances of the phrase “in one embodiment” in various places in the specification are not necessarily referring to the same embodiment.

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The word “exemplary” is used herein to mean “serving as an example or illustration.” Any aspect or design described herein as “exemplary” is not necessarily to be construed as preferred or advantageous over other aspects or designs. Likewise, the phrases “particularly,” “preferably,” or the like as used in this disclosure may refer to an element or value that provides advantage(s) in some embodiment(s), however is not intended to limit the scope of the disclosure to those “particular” or “preferable” features.

Transitional language such as “including,” “comprising,” “having,” “containing,” “involving,” or variations thereof, is intended to be broad and encompass the subject matter listed thereafter, equivalents, and additional subject matter not recited, i.e., to be open-ended and meaning including but not limited to.

It is to be understood that terms such as “top,” “bottom,” “upper,” “lower,” “left,” “right,” “front,” “rear,” “forward,” “rearward,” or the like may refer to an arbitrary frame of reference, rather than to the ordinary gravitational frame of reference.

It is to be understood that all values, ranges, ratios or the like as described in this disclosure may be combined in any manner. In addition, it is to be understood that a concentration or amount or value range listed in this disclosure is intended to include any and every concentration or amount or value within the range, including the end points, as if each value within the range has been expressly stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that the inventor(s) appreciate and understand that any and all data points within the range are to be considered to have been specified, and that inventor(s) had possession of the entire range and all points within the range.

In addition, each numerical value used in this disclosure should be read once as modified by the term “about” (unless already expressly so modified), and then read again as not so modified unless otherwise indicated in context. The term “about” as used herein refers to any value which lies within the range defined by a variation of up to ±10% of the stated value, for example, ±10%, ±9%, ±8%, ±7%, ±6%, ±5%, ±4%, ±3%, ±2%, ±1%, ±0.01%, or ±0.0% of the stated value, as well as values intervening such stated values. When the term “about” is used in describing a value or an end-point of a range, the disclosure should be understood to include the specific value or end-point referred to.

The term “consisting essentially of” in relation to a composition is to indicate that substantially (e.g., greater than 95 weight % or greater than 99 weight %) of the component(s) present in the composition is the component(s) recited. Therefore, this term does not exclude the presence of minor additives or impurities as would be understood by those having ordinary skill in the art.

Although the invention has been shown and described with respect to a certain embodiment or embodiments, it is apparent that equivalent alterations and modifications will occur to those having ordinary skill in the art upon the reading and understanding this disclosure, and such modifications are intended to be included within the scope of this disclosure as defined in the claims. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure.

1. A fuel dispenser system, comprising:
a fuel dispenser fluidly coupled to a source of fuel;
a fuel dispenser hose fluidly coupled to the fuel dispenser for dispensing the fuel through a nozzle coupled to an end of the fuel dispenser hose;
wherein the fuel dispenser hose comprises:
an inner tube layer defining an internal lumen of the hose, the inner tube layer being formed from a first elastomeric composition having at least one fluoro-thermoplastic vulcanizate adhesion promoting agent;
a barrier layer arranged over the inner tube layer, wherein the barrier layer is formed from a fluoro-thermoplastic vulcanizate (F-TPV);
an intermediate layer arranged over the barrier layer, wherein the intermediate layer is formed from a second elastomeric composition having at least one fluoro-thermoplastic vulcanizate adhesion promoting agent;
a reinforcement layer arranged over the intermediate layer, wherein the reinforcement layer is formed with braided steel wire; and
an outermost cover layer arranged over the reinforcement layer, wherein the cover layer is formed from a third elastomeric composition;
wherein the F-TPV barrier layer provides:
(i) a flexural modulus according to ASTM D790 or a tensile modulus according to ASTM D638 of 700 MPa or less;
(ii) an elongation at break of greater than 250% when tested according to ASTM D638;
(iii) a fatigue performance of greater than 250,000 cycles in tension and greater than 1 million cycles in compression, when tested according to ASTM D3629;
(iv) a bond strength between the F-TPV barrier layer and the inner tube layer of greater than a tear strength of the inner tube layer, which is greater than at least 15 lbf/in, when tested according to ASTM D413;
(v) a bond strength between the F-TPV barrier layer and the intermediate layer of greater than a tear strength of the intermediate layer, which is greater than at least 15 lbf/in, when tested according to ASTM D413; and
(vi) a permeation rate of the overall hose which is less than 10 g/m²/day with CE10 fuel, when tested according to UL330.

2. The system according to claim 1, wherein the first elastomeric composition of the inner tube layer is a nitrile rubber composition, and the at least one fluorothermoplastic adhesion promoting agent includes (a) at least one metal oxide selected from the group consisting of magnesium oxide, calcium oxide, and hydrotalcite, and (b) an organo-onium salt, or a diamine salt.

3. The system according to claim 2, wherein the metal oxide is present at a level within the range of 15 phr to 40 phr; wherein the organo-onium salt is present at a level within the range of 3 phr to 8 phr; and wherein the diamine salt is present at a level within the range of 1 phr to 4 phr.

4. The system according to claim 3, wherein the nitrile rubber composition of the inner tube layer includes nitrile rubber with an acrylonitrile content within the range of about 28 weight percent to about 50 weight percent.

5. The system according to claim 4, wherein the nitrile rubber composition of the inner tube further comprises of at least one reinforcing filler present at a level which is within the range of 10 phr to 150 phr.

6. The system according to claim 4, wherein the first elastomeric composition of the inner tube layer and the second elastomeric composition of the intermediate layer are the same.

7. The system according to claim 1, wherein the braided steel wire of the reinforcement layer is brass plated and has a wire pack coverage which is within the range of about 30 percent to about 60 percent.

8. The system according to claim 1, wherein the third elastomeric composition of the cover layer is a chlorinated polyethylene rubber composition.

9. The system according to claim 8, wherein the chlorinated polyethylene rubber composition of the cover layer has a chlorine content which is within the range of 30 percent to 36 percent.

10. The system according to claim 1, wherein the inner tube layer is from 0.045 inch to 0.095 inch thick; wherein the barrier layer is from 0.003 inch to 0.017 inch thick; wherein the intermediate layer is 0.015 inch to 0.075 inch thick; wherein the cover layer is 0.050 inch to 0.1 inch thick; and wherein said hose has an inside diameter which is within the range of 0.720 inch to 0.780 inch.

11. The system according to claim 1, wherein the hose consists of the inner tube layer, the barrier layer, the friction layer, the reinforcement layer, and the cover layer.

12. The system according to claim 1, wherein:
the first elastomeric composition of the inner tube layer is a nitrile rubber composition, and the at least one fluorothermoplastic adhesion promoting agent includes (a) at least one metal oxide selected from the group consisting of magnesium oxide, calcium oxide, and hydrotalcite, and (b) an organo-onium salt, or a diamine salt; wherein the metal oxide is present at a level within the range of 15 phr to 40 phr; wherein the organo-onium salt is present at a level within the range of 3 phr to 8 phr; and wherein the diamine salt is present at a level within the range of 1 phr to 4 phr; wherein the nitrile rubber composition of the inner tube layer includes nitrile rubber with an acrylonitrile content within the range of about 28 weight percent to about 50 weight percent;
the second elastomeric composition of the intermediate layer is a nitrile rubber composition, and the at least one fluorothermoplastic adhesion promoting agent of the second elastomeric composition includes (a) at least one metal oxide selected from the group consisting of magnesium oxide, calcium oxide, and hydrotalcite, and (b) an organo-onium salt, or a diamine salt; wherein the metal oxide is present at a level within the range of 15 phr to 40 phr; wherein the organo-onium salt is present at a level within the range of 3 phr to 8 phr; and wherein the diamine salt is present at a level within the range of 1 phr to 4 phr; wherein the nitrile rubber composition of the intermediate layer includes nitrile rubber with an acrylonitrile content within the range of about 28 weight percent to about 50 weight percent;
the braided steel wire of the reinforcement layer is brass plated and has a wire pack coverage which is within the range of about 30 percent to about 60 percent;
the third elastomeric composition of the cover layer is a chlorinated polyethylene rubber composition, wherein the chlorinated polyethylene rubber composition of the cover layer has a chlorine content which is within the range of 30 percent to 36 percent; and
the inner tube layer is from 0.045 inch to 0.095 inch thick; wherein the barrier layer is from 0.003 inch to 0.017 inch thick; wherein the intermediate layer is 0.015 inch to 0.075 inch thick; wherein the cover layer is 0.050 inch to 0.1 inch thick; and wherein said hose has an inside diameter which is within the range of 0.720 inch to 0.780 inch.

13. A method of using the system according to claim 1, comprising:
transferring the fuel through the hose via the fuel dispenser; and
dispensing the fuel through the nozzle.

14. A method of use of selecting materials and construction of a reinforced multilayer fuel dispensing hose for its specified use in a fuel dispensing system, comprising:
selecting a tube material and construction to form an inner tube layer based at least upon inner tube properties including flexibility and chemical resistance to hydrocarbon fuel when used in the fuel dispensing system;
constructing the inner tube layer with the selected tube material and construction as the innermost layer of the hose which defines a lumen, wherein the selected tube material is an elastomeric composition having at least one fluoro-thermoplastic vulcanizate adhesion promoting agent; and the construction of the inner tube layer with the selected elastomeric composition satisfies the inner tube properties when the hose is cured;
selecting a barrier material and construction to form a barrier layer based at least upon barrier layer properties;
constructing the barrier layer with the selected barrier material and construction outwardly of the tube layer, wherein the selected barrier material is a fluoro-thermoplastic vulcanizate (F-TPV), and the construction of the barrier layer with the selected F-TPV satisfies the barrier layer properties when the hose is cured;
selecting an intermediate layer material and construction to form an intermediate layer based at least upon intermediate layer properties;
constructing the intermediate layer with the selected intermediate layer material and construction outwardly of the barrier layer, wherein the selected intermediate layer is an elastomeric composition having at least one fluoro-thermoplastic vulcanizate adhesion promoting agent, and the construction of the intermediate layer with the selected elastomeric composition satisfies the intermediate layer properties when the hose is cured;
selecting a reinforcement material and construction to form a reinforcement layer based at least upon reinforcement layer properties including flexibility without kinking and strength to resist burst pressure when used in the fuel dispensing system;
constructing the reinforcement layer with the selected reinforcement material and construction outwardly of the barrier layer, wherein the selected reinforcement material and construction includes braided steel wire, and the construction of the reinforcement layer with the selected braided steel wire satisfies the reinforcement layer properties when the hose is cured;
selecting a cover material and construction to form a cover layer based at least upon cover layer properties including flexibility and environmental resistance when used in the fuel dispensing system;
constructing the cover layer with the selected cover material and construction outwardly of the reinforcement layer and forming the outermost layer of the hose, wherein the selected cover material is an elastomeric composition, and the construction of the cover layer with the selected elastomeric composition satisfies the cover layer properties when the hose is cured;
wherein the selecting of the barrier layer properties and constructing of the barrier layer with the selected F-TPV that satisfies the barrier layer properties is based at least upon the F-TPV providing:
(i) a flexural modulus according to ASTM D790 or a tensile modulus according to ASTM D638 of 700 MPa or less;
(ii) an elongation at break of greater than 250% when tested according to ASTM D638;
(iii) a fatigue performance of greater than 250,000 cycles in tension and greater than 1 million cycles in compression, when tested according to ASTM D3629;
(iv) a bond strength between the F-TPV barrier layer and the inner tube layer of greater than a tear strength of the inner tube layer, which is greater than at least 15 lbf/in, when tested according to ASTM D413;
(v) a bond strength between the F-TPV barrier layer and the intermediate layer of greater than a tear strength of the intermediate layer, which is greater than at least 15 lbf/in, when tested according to ASTM D413; and
(vi) a permeation rate of the overall hose which is less than 10 g/m²/day with CE10 fuel, when tested according to UL330;
the method further comprising: curing the reinforced multilayer fuel dispensing hose with its respectively constructed layers, such that each of the respective layers, as constructed with its selected material, satisfies its respective properties, and the overall hose it is suitable for use in the fuel dispensing system.
